(19) United States
(12) Patent Application Publication
(10) Pub. No.: US 2022/0145907 A1
(43) Pub. Date: May 12, 2022

(54) DEVICE FOR GENERATING NEGATIVE PRESSURE

(71) Applicant: Deutsches Institut für Lebensmitteltechnik e.V., Quakenbrück (DE)

(72) Inventor: Bernhard Hukelmann, Quakenbrück (DE)

(21) Appl. No.: 17/433,846

(22) PCT Filed: Feb. 25, 2020
(86) PCT No.: PCT/EP2020/054917

§ 371 Date: Aug. 25, 2021

(30) Foreign Application Priority Data
Feb. 25, 2019 (DE) 102019202540.4

(51) Int. Cl. F04F 5/20; B65G 47/91

(52) U.S. Cl. CPC F04F 5/20; B65G 47/91

(57) ABSTRACT

A device for generating negative pressure by a pressurized fluid, which device comprises an inflow channel and an outflow channel and, for a pressurized fluid, an injection channel, the outlet of which is arranged at a distance from the inlet of the inflow channel. In the device, the inflow channel, the injection channel and the outflow channel are arranged along a common longitudinal center axis. The injection channel is arranged between the inflow channel and the outflow channel. By arranging the inflow channel, the injection channel and the outflow channel along a common longitudinal center axis, a favorable flow pattern is obtained, which preferably allows for efficient generation of a negative pressure at the inlet of the inflow channel by means of the pressurized fluid.

The present invention provides a device and a process, which process can be carried out by the device, for generating negative pressure, which is driven by a pressurized fluid. The pressurized fluid can be a liquid under positive pressure, preferably a gas under positive pressure, also referred to as a pressurized gas. The device is characterized by an elongated structural form and by a flow pattern that allows for energy-efficient generation of negative pressure.

For a pressurized fluid, known jet pumps have a propelling nozzle that is arranged on a common longitudinal central axis together with a mixing chamber, the cross-section of which can run in from its inlet and widen out to an outlet lying opposite thereto, wherein the inlet for an aspirated fluid is connected radially to the longitudinal central axis in the area in which the propelling nozzle discharges at a distance in front of the mixing chamber.

### PRIOR ART

DE 3457645 A1 shows a gas jet pump in which an injection channel for a pressurized fluid opens colinearly into an outflow channel which is supported in a pipe section. This pipe section by means of a flange connection is attached to the housing surrounding the injection channel. The flange connection seals by means of an annular projection on the outside of the injection channel, or by means of a single sealing ring which is pressed in between the outside of the injection channel and the inner edges of the flange of the housing and the flange of the pipe section, which inner edges are adjacent to one another.

### OBJECT OF THE INVENTION

The invention has the object to provide an alternative device and a process that can be carried out by the device, which allow for the supply of a pressurized fluid between the inlet and outlet of the device, and which shall further preferably allow for energy-efficient generation of negative pressure. Further, the device shall be easy to clean, preferably shall be easy to disassemble and to assemble without tools in order to facilitate cleaning of the channels.

### DESCRIPTION OF THE INVENTION

The invention achieves the object by the features of the claims and in particular by a device for generating negative pressure by means of a pressurized fluid, which device comprises an inflow channel and an outflow channel, and for a pressurized fluid comprises an injection channel, the outlet of which is arranged at a distance from the inlet of the inflow channel. In the device, the inflow channel, the injection channel and the outflow channel are arranged along a common longitudinal center axis, wherein the injection channel and the outflow channel have round inner cross-sections. Therein, the injection channel is arranged between the inflow channel and the outflow channel. The arrangement of the inflow channel, injection channel and outflow channel along a common longitudinal center axis results in a favorable flow pattern, which preferably allows for efficient generation of a negative pressure at the inlet of the inflow channel by means of the pressurized fluid flowing out of the injection channel.

The negative pressure acts through the inflow channel up to its inlet, and the inflow channel directs fluid that is aspirated into the inlet to its outlet. The outlet of the injection channel is arranged at the outlet of the inflow channel, and the inlet of the outflow channel is arranged at a distance therefrom. Therein, the outlet of the inflow channel and the outlet of the injection channel face the inlet of the outflow channel. Due to the coaxial arrangement of the injection channel and the inflow channel, and due to the coaxial arrangement of the outlet of the inflow channel around the outlet of the injection channel, the fluid aspirated through the inflow channel is directed in the same direction and in parallel to the pressurized fluid, both of which flow in the same direction into the inlet of the outflow channel. The outflow channel directs the pressurized fluid in mixture with aspirated fluid from its inlet to its outlet.

The injection channel in a first section tapers from its inlet and preferably adjacent in a terminal section widens towards its outlet. The terminal section of the injection channel can have a constant cross-section, can taper towards its outlet, or preferably widens towards its outlet and forms a Laval nozzle. Optionally, the injection channel between its first section and its terminal section has a second section of constant diameter.

The injection channel can be formed entirely or sectionally within the carrier. Optionally, the terminal section of the injection channel can be formed entirely within the carrier, and e.g. the outlet of the injection channel can be arranged flush with a surface of the carrier, e.g. flush with the terminal cross-section of the carrier.

Preferably, the injection channel adjacent to its outlet has a cantilevered section that is connected only to at least one or to exactly one carrier projecting radially into the inflow channel, which carrier supports this cantilevered section of the injection channel. The inlet of the injection channel is connected to a supply line for pressurized fluid, which supply line is arranged within the carrier and has a connecting section extending radially to the longitudinal center axis. The connecting section of the supply line for pressurized fluid, which connecting section extends radially to the longitudinal central axis, opens in a connection, e.g. a screw connection, on the outside of the device in an area along the device, e.g. on the outside of the device between the inlet of the inflow channel and the outlet of the injection channel.

Preferably, the supply line within the carrier has a section that extends along the common longitudinal center axis up to adjacent to the inlet of the injection channel, wherein said section of the supply line for pressurized fluid preferably has a cylindrical cross-section which is equal to the cross-section of the inlet at the first section of the injection channel.

The carrier extends radially into the inflow channel and can exclusively consist of one carrier extending from the wall of the inflow channel to the injection channel and containing the injection channel, or the carrier can consist of two parts, each extending from the wall of the inflow channel to the injection channel, e.g. at an angle between the parts of the carrier of 90° to preferably 180°, e.g. about the longitudinal center axis. Therein, in each part of the carrier, a part of the supply line can be formed, so that the connecting section of the supply line is also formed in two parts that each extend radially to the longitudinal center axis in a respective part of the carrier.

At its outlet, the inlet channel forms a section of annular cross-section around the cantilevered section of the injection channel up to adjacent to the inlet of the outlet channel. It has shown that the annular cross-section of the inflow channel around the cantilevered section of the injection channel is preferably formed coaxially around the common longitudinal center axis.

Preferably, the inlet of the outflow channel is arranged at a distance from the injection channel, or resp. from the outlet thereof. Less preferably, the outlet of the injection channel is arranged within a first section of the outflow channel, wherein an annular clear cross-section is formed between the outer surface of the cantilevered section of the injection channel and the first section of the outflow channel. Fluid exiting from the inflow channel can flow into this annular clear cross-section.

The outflow channel in a first section tapers from its inlet towards a second section of constant diameter, and in a third section adjacent to its second section widens towards its outlet.

A suction bell can be connected to the inlet of the inflow channel, such that the negative pressure is directed through the inflow channel into the interior of the suction bell.

Optionally, the carrier with the injection channel, including the cantilevered section of the injection channel, is formed single-pieced with the inflow channel. Optionally, the outflow channel is formed single-pieced with the inflow channel and the injection channel.

Preferably, the outflow channel is formed in a tubular element having a terminal section that is detachably connected, e.g. by a clamping joint or screw connection, to the inflow channel and encloses the cantilevered section of the injection channel. The clamping joint can be a simple push-fit connection or a bayonet connection, wherein a terminal section of the tubular element in which the outflow channel is formed encloses the section of the central piece in which the cantilevered section of the injection channel is arranged, or wherein the section of the central piece in which the cantilevered section of the injection channel is arranged encloses a terminal section of the tubular element in which the outflow channel is formed. Generally preferably, a terminal section of the tubular element in which the outflow channel is formed is connected to the central piece exclusively by the terminal section of the tubular element encompassing the central piece or being encompassed by the central piece in the area in which the cantilevered section of the injection channel is arranged.

Preferably, the inflow channel is formed by a central piece containing the carrier and the injection channel, and by a pipe piece detachably connected to the central piece. The central piece contains the injection channel including its cantilevered section and the supply line, and is preferably formed single-pieced.

The pipe piece, in which a part of the inflow channel is arranged or formed, can have a section enclosing the area having the annular cross-section and/or enclosing the area which is formed at least partially by the carrier. Preferably, the pipe piece, in which a part of the inflow channel is arranged or formed, has a section enclosing the area of the central piece, in which area a part of the supply line, in particular a connecting section of the supply line is arranged, which connecting section extends radially to the longitudinal center axis. Therein, the section of the pipe piece enclosing the central piece can form a part of the wall of the supply line, in particular can form a part of its connecting section. Alternatively, the wall, which delimits the area of annular cross-section in its outer diameter, can be formed by a section of the pipe piece. The section of the pipe piece can e.g. form a detachable clamping joint, plug connection or screw connection with the central piece in which the cantilevered section of the injection channel is arranged.

Generally, embodiments are preferred in which a central piece, which encloses the carrier and the injection channel and the supply line, is detachably connected to a pipe piece in which a section of the inflow channel is arranged or formed, and/or is detachably connected to a tubular element in which the outflow channel is formed. The tubular element can have a terminal section that is detachably connected to the inflow channel or to the central piece and that e.g. encloses the cantilevered section of the injection channel. Such embodiments have the advantage of allowing easy cleaning after removal of the central piece from the pipe piece and/or from the tubular element, e.g. in a process for aspirating an object by means of the device. Accordingly, the invention also relates to a process for cleaning, the process comprising the step of removing the central piece from the pipe piece and/or from the tubular element, removing deposits, e.g. by means of pressurized gas or by flushing with a liquid, and reconnecting the central piece to the pipe piece and/or the tubular element. The device and process have the advantage of being able to clean aspirated components of the object, which can e.g. be a food or dust, after simple disassembly of the device by removing the detachably connected components, and subsequently being able to reconnect the components. Generally, the pipe piece can span open a recess into which a section of the central piece is inserted or screwed, which section lies opposite to the tubular element. Therein, the section of the central piece, which section is insertable into the recess of the pipe piece, preferably has circumferential sealing rings. It has shown that a simple clamping joint is sufficiently tight, in which a section of the central piece provided with circumferential sealing rings is inserted into a recess of the pipe piece. The recess of the pipe piece can e.g. be cylindrical, optionally having cylindrical sections of different diameters.

It has shown that a detachable connection, e.g. in the form of a plug-in connection or clamping joint, a bayonet lock or a screw connection with at least one thread made of plastic, in which connection a terminal section of the tubular element, in which the outflow channel is formed, encloses or is enclosed by the section of the central piece in which the cantilevered section of the injection channel is arranged, forms a sufficiently stable connection of this tubular element to the central piece. The stability of this connection, even in the case of a simple clamping joint or plug-in connection, is currently attributed to the fact that a fluid exiting from the injection channel and entering the outflow channel creates a negative pressure between them. The clamping joint can e.g. be formed by respective rotationally symmetrical surfaces that are slidable over one another along the longitudinal center axis. Generally, it is preferred that a plug-in connection or clamping joint is formed rotationally symmetrical and further preferably does not have a thread.

Preferably, the central piece is connectable to a recess of a pipe piece exclusively by sliding along the longitudinal center axis, further preferably without rotational movement. Generally, the pipe piece can span open the recess to receive a section of the central piece and can be part of a plate, of a wall, or of a suction bell.

In the process for aspirating an object, the supply line to the injection channel is preferably supplied with pressurized air as a pressurized fluid. In this process for generating negative pressure at the inlet of the inflow channel, it has shown that the tubular element in which the outflow channel is formed is pulled towards the central piece. The tubular element in which the outflow channel is formed was easily slid onto the section of the central piece by hand. This clamping joint was sufficiently stable, because the tubular element is pulled towards the central piece when pressurized fluid is applied to the injection channel.

In one embodiment, the inflow channel is fixedly connected to the central piece, e.g. formed single-pieced, and a tubular element containing the outflow channel is detachably connected to the central piece, in particular by means of a clamping joint or plug-in connection.

These and alternative embodiments can be single-pieced and can e.g. be produced by a three-dimensional printing process from a curing plastic composition, which e.g. is a thermoplastic or a thermosetting plastic composition.

Preferably, the device has a silencer formed by an elastic hose piece which is arranged tightly at the outlet of the outflow channel, the opposite end of which elastic hose piece is closed and which elastic hose piece has at least one slot in its wall. Such a hose piece can be tightly attached to a ring which is detachably connected, in particular only clampingly and longitudinally displaceably, to the outer surface of the outflow channel.

Preferably, the supply line for pressurized fluid has an annular section formed in a pipe piece, through which annular section pressurized fluid can flow into the injection channel in any rotational position of the central piece to the pipe piece. Therein, the section of the central piece which lies opposite to the tubular element is preferably arranged in a clamping and rotatable manner in a recess of a pipe piece in which an annular section of a supply line for pressurized fluid is formed, which annular section is connected to the injection channel in a fluid-tight manner.

In the process, a pressurized fluid is applied to the supply line, the pressurized fluid flowing into the injection channel, namely flowing through the inlet of the injection channel into its first section, flowing through the optional second section of the injection channel and through its terminal section, and exiting from its outlet and entering into the inlet of the outflow channel, thereby accelerating fluid aspirated through the inflow channel into the outflow channel, which fluid flows from the outlet of the inflow channel into a section of annular cross-section which is formed by the inflow channel around the cantilevered section of the injection channel. The pressurized fluid, in admixture with the fluid aspirated through the inflow channel, flows through a first section of the outflow channel, through the second section thereof, and through the third section thereof, and exits from the outlet of the outflow channel. Therein, fluid aspirated through the inflow channel flows around the carrier which extends radially into the inflow channel and in which the pressurized fluid flows through the injection channel.

In the process, the pressurized fluid is preferably a pressurized gas, e.g. air or nitrogen, which e.g. supplies the supply line with a positive pressure of 0.1 to 10 bar, e.g. 1 to 5 bar.

The figures show embodiments of the device. Therein, identical reference numerals denote functionally identical elements.

The invention is now described with reference to the figures:

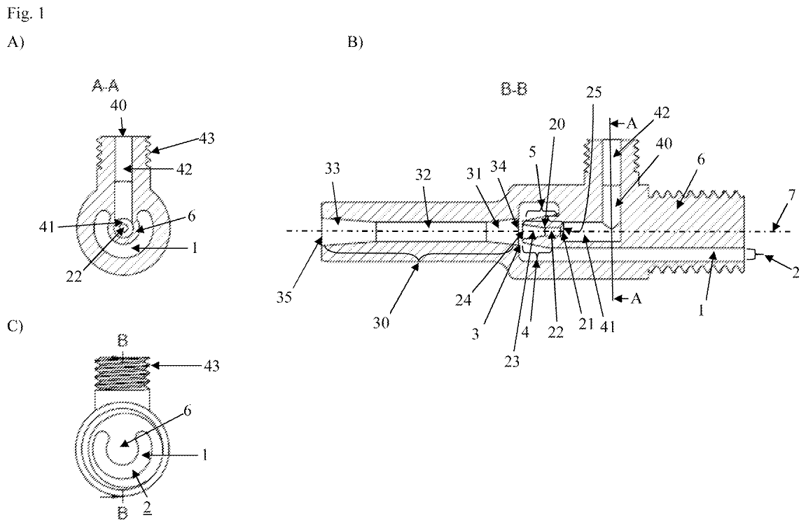

FIG. 1 shows a single-pieced embodiment of the device, in A) in section A-A in perpendicular to the longitudinal center axis, in B) in longitudinal section B-B along the longitudinal center axis, in C) in top view onto the inlet of the inflow channel,

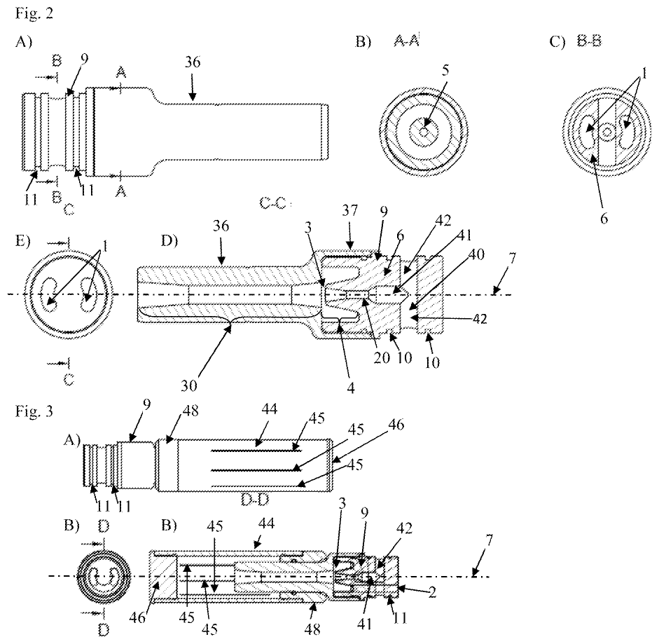

FIG. 2 shows a two-pieced embodiment of the carrier and of the outflow channel A) in top view, B) in section A-A, and C) in section B-B, in D) in longitudinal section C-C of the top view E) onto the carrier from the perspective of the inlet of the inflow channel,

FIG. 3 shows an embodiment having a silencer on the outlet channel, in A) in top view, in B) in longitudinal section,

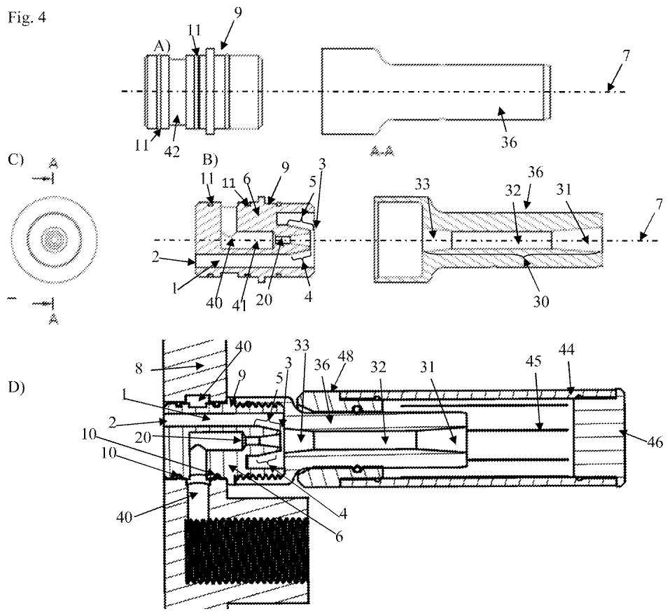

FIG. 4 shows an embodiment in exploded view, in A) in top view, in B) in longitudinal section A-A, in C) in top view onto the outlet of the outflow channel, in each case without showing the inflow channel, in D) an embodiment arranged in a recess of a pipe piece, and

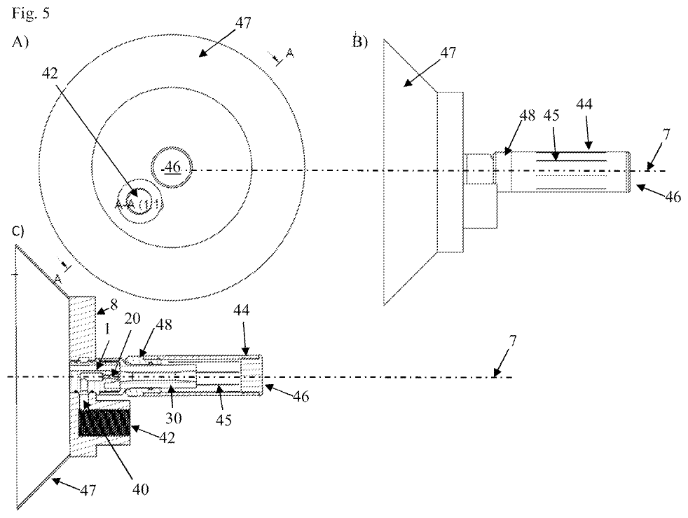

FIG. 5 shows a device connected to a suction bell, in A) in top view onto the outer surface of the suction bell or resp. from the direction onto the outlet of the outflow channel, in B) in side view onto the device, and in C) in section A-A of A) in parallel to the longitudinal center axis.

FIG. 1 shows a device having an inflow channel 1 extending from its inlet 2 to its outlet 3, which inflow channel 1 forms an area 4 of annular cross-section around the cantilevered section 5 of the injection channel 20. The cantilevered section 5 of the injection channel 20 terminates with the outlet 24 of the injection channel 20, which adjacent to its inlet 25 has a first section 21 that tapers from its inlet 25 to a second section 22 having a constant cross-section. From the second section 22, the cross-section of the injection channel 20 increases in an adjacent terminal section 23 up to its outlet 24. The injection channel 20 is formed in a carrier 6 which extends radially from the wall into the inflow channel 1 and which restricts the cross-section of the inflow channel 1, at least in sections, to a sectional annular shape, or resp. to a C-shape. The carrier 6 is formed single-pieced with the injection channel 20 and its cantilevered section 5.

The outflow channel 30 extends from its inlet 34 at its first section 31, the cross-section of which tapers to a second section 32 of constant diameter, through its second section and through an adjacent third section 33, the cross-section of which widens towards its outlet 35.

In the variant shown here, the outlet 24 of the injection channel 20 is arranged at a distance from the inlet 34 of the outflow channel 30, so that between the outlet 24 of the injection channel 20 and the inlet 34 of the outflow channel 30, an annular region is delimited which is in connection to the area 4 of annular cross-section that is spanned open by the inflow channel 1.

A supply line 40 for pressurized fluid is connected to the inlet 25 of the injection channel 20 and, according to a preferred embodiment, has a coaxial section 41 along the longitudinal center axis 7, which coaxial section 41 has the same diameter as the inlet 25 of the injection channel 20. A connecting section 42 of the supply line 40 for pressurized fluid extends radially with respect to the longitudinal center axis 7 and discharges into a screw connection 43 on the outside of the device.

In this embodiment, the entire device is formed single-pieced. This embodiment could be manufactured by means of 3D printing, e.g. by depositing a hardening plastic compound layer by layer, starting from the area of the inlet 2 of the inflow channel 1 in the direction towards the outlet 35 of the outflow channel 30.

FIG. 2 shows a preferred embodiment in which the carrier 6 together with the injection channel 20, including its cantilevered section 5, and the supply line 40 and at least a section of the area 4 having an annular cross-section are contained in a central piece 9, to the one end of which a tubular element 36 is detachably connectable and to the opposite end of which a pipe piece 8 is detachably connectable. Due to the position of the sectional plane in FIG. 2D), the inflow channel 1 that is formed in the central piece 9 is not visible there. The outflow channel 30 is formed in the tubular element 36. The tubular element 36 has a terminal section 37 which encloses the cantilevered section 5 of the injection channel 20 and which is detachably connected to the inflow channel 1 or to the central piece 9, here by means of a clamping joint. The central piece 9 of this embodiment has a connecting piece, formed by the section lying opposite to the tubular element 36, for the clamping joint to a pipe piece 8 in which the inflow channel 1 is to be arranged or is formed.

FIG. 2 in D) shows an embodiment in which the carrier 6 extends in two parts through the inflow channel 1 and divides it into two parts in the area of the carrier 6, as shown in FIGS. 2C) and 2E). The inlet channel 40 is formed in two parts, each extending radially with respect to the longitudinal center axis 7 in a respective part of the carrier 6. The formation of the carrier 6 in two parts extending radially through the inflow channel 1 can be formed in the preferred embodiment in which the carrier 6, the injection channel 20 and the supply line 40 are formed in a central piece 9, and the outflow channel 30 is contained in a tubular element 36 which is detachably connected to the central piece 9, and the inflow channel 1 is contained in a tubular piece 8 (shown sectionally in FIG. 4D), which is detachably connected to the central piece 9.

FIG. 2B) shows that the inflow channel 1 forms the area 4 of annular cross-section around the cantilevered section 5 of the injection channel 20.

FIGS. 3 in A) and B) shows a preferred embodiment of the device, in which embodiment the inflow channel 1 is not shown, with a silencer having an elastic hose piece 44 with at least one slot 45 as an opening, presently arranged in parallel to the longitudinal center axis 7. The hose piece 44 overlaps the outlet 35 of the outlet channel 30 and is closed by a terminal cover 46. The hose piece 44 can be connected to the outflow channel 30 by means of a ring 48 which encloses the outflow channel 30 in a clamping manner.

FIG. 4 in A) in top view as well as in B) in longitudinal section shows a central piece 9 and a tubular element 36, and in C) in cross-section A-A through a tubular element 36 shows a preferred embodiment in which both the outflow channel 30 is formed in a tubular element 36 and is detachably connected to the carrier 6, and the inflow channel 1 is formed in a pipe piece 8 which opposite to the tubular element 36 is detachably connected to the carrier 6. The tubular element 36 that forms the outflow channel 30, and the pipe piece 8 that forms the inflow channel are each attached to the carrier 6 by a releasable connection, which carrier 6 contains the injection channel 20 and the supply line 40. The releasable connections can, each independently from one another, be e.g. plug-in connections, e.g. clamping joints, or can be screw connections, which are preferably fluid-tight. The tubular element 36 has a section enclosing the area 4 of annular cross-section that is formed by the carrier 6. Alternatively, the wall, which delimits the area 4 of annular cross-section in its outer diameter, can be formed by a section of the tubular element 36. The circumferential grooves 11 are provided for receiving sealing rings 10, which form a fluid-tight clamping joint between this section of the central piece 9 and a cylindrical recess, e.g. of a pipe piece, in which the outlet 2 of the inflow channel 1 opens in order to apply negative pressure there.

In FIG. 4D), the embodiment having an additional hose piece 44 is shown, which has slots 45 and a terminal cover 46 as a silencer, arranged on a pipe piece 8. The section of the central piece 9, which lies opposite to the tubular element 36 containing the outflow channel 30, is inserted into a cylindrical recess of the pipe piece 8. This section of the central piece 9 has sealing rings 10 arranged in circumferential grooves 11, which sealing rings 10 seal the section of the central piece 9 against the cylindrical recess in the pipe piece 8. Since negative pressure is generated at the inlet 2 of the inflow channel 1 when pressurized fluid is applied to the injection channel 20, a simple plug-in connection without latching or threading between the central piece 9 and the pipe piece 8 is sufficient to hold the central piece 9 to the pipe piece 8. As generally preferred, the pipe piece 8 is part of a wall which can e.g. be plate-shaped or can be part of a suction bell. As generally preferred, the supply line 40 has an annular section through which pressurized fluid can flow into the injection channel 20 in any rotational position of the central piece 9.

FIG. 5 in A) to C) shows a device having a suction bell 47 that is connected to the inlet 2 of the inflow channel 1 so that a fluid can be aspirated from within the suction bell 47 through the inflow channel 1 to generate a negative pressure within the suction bell 47. In this embodiment, the inflow channel 1 is formed single-pieced with the central piece 9, and the tubular element 36 in which the outflow channel 30 is formed, is detachably connected to the central piece 9.

List of reference signs:

1 inflow channel
2 inlet of the inflow channel
3 outlet of the inlet channel
4 area of annular cross-section
5 cantilevered section of the injection channel
6 carrier
7 longitudinal center axis
8 pipe piece
9 central piece
10 sealing ring
11 groove for sealing ring
20 injection channel
21 first section of the injection channel
22 second section of the injection channel
23 terminal section of the injection channel
24 outlet of the injection channel
25 inlet of the injection channel
30 outflow channel
31 first section of the outflow channel
32 second section of the outflow channel
33 third section of the outflow channel
34 inlet of the outflow channel
35 outlet of the outflow channel
36 tubular element
37 terminal section of the tubular element
40 supply line
41 coaxial section of the supply line
42 connecting section of the supply line
43 screw connection
44 hose piece
45 slot
46 terminal cover
47 suction bell
48 ring

1. A device for generating negative pressure by a pressurized fluid, the device comprising an inflow channel and an outflow channel, and an injection channels, an outlet of which is arranged at a distance from an inlet of the inflow channel, wherein
the inflow channel, the injection channel and the outflow channel are arranged along a common longitudinal center axis,
the injection channel and the outflow channel have round inner cross-sections, and
the injection channel in a first section from its inlet tapers and has an outlet in a terminal section, and
the injection channel is at least sectionally enclosed in a carrier projecting radially into the inflow channels, and the inlet of the injection channel is connected to a supply line for pressurized fluid, which supply line is arranged inside of the carrier and has a connecting section extending radially with respect to the longitudinal center axis,
wherein said inflow channel forms an area of annular cross-section around a cantilevered section of the injection channel up to adjacent to the inlet of the outflow channel,
wherein the inlet of the outflow channel is arranged at a distance from the outlet of the injection channel or the outlet of the injection channel is arranged within the outflow channel, and
wherein the outflow channel in a first section from its inlet tapers towards a second section of constant diameter, and adjacently widens in a third section towards its outlet, wherein the carrier, the injection channel and the supply line are contained in a central piece and in that the outflow channel is formed in a tubular element, which is detachably connected to the central piece exclusively in that an end section of the tubular element, in which end section the outflow channel is formed, encloses or is enclosed by the section of the central piece in which the cantilevered section of the injection channel is arranged.

2. The device according to claim 1, wherein the tubular element is detachably connected to the central piece exclusively in that the connection is a plug-in connection or a bayonet connection.

3. The device according to claim 1, wherein the central piece contains the injection channel including its cantilevered section and the supply line, and in that the central piece is formed as a single piece.

4. The device according to claim 1, wherein the carrier, the injection channel and the supply line are contained in a central piece, and in that at least a part of the inflow channel is arranged or formed in a pipe piece which is detachably connected to the central piece.

5. The device according claim 1, wherein the inflow channel is formed as a single piece with the central piece.

6. The device according to claim 1, wherein the inflow channel in the section in which the carrier projects into the inflow channel has an area of annular cross-section into which the carrier projects and the inner radius of the inflow channel is delimited by the carrier.

7. The device according to claim 1, wherein the injection channel in a terminal section widens towards its outlet and/or the injection channel adjacent to its outlet has a cantilevered section which is connected only to one carrier projecting radially into the inflow channel.

8. The device according to claim 1, wherein the injection channel from its inlet in its first section tapers towards a second section of constant diameter and in an adjacent terminal section widens towards its outlet.

9. The device according to claim 1, wherein the carrier projects radially through the inflow channel and the inflow channel consists of two partial channels between which the carrier is arranged.

10. The device according to claim 1, wherein the carrier is formed as a single piece with the cantilevered section of the injection channel and with the inflow channel.

11. The device according to claim 1, wherein the tubular element, in which the outflow channel is formed, has a terminal section which is detachably connected to the inflow channel or to the central piece, and which encloses the cantilevered section of the injection channel.

12. The device according to claim 1 formed entirely as a single piece.

13. The device according to claim 1, wherein the outlet of the injection channel has a smaller cross-section than the inlet of the outflow channel.

14. The device according to claim 1, wherein the cantilevered section of the injection channel has an outer diameter which decreases towards the outlet of the injection channel.

15. The device according to claim 1, wherein a ring is detachably connected to and longitudinally displaceable along the outer surface of the outflow channel, and an elastic hose piece, which has at least one slit in its wall and is closed at one end, is attached to the ring and encloses the outlet of the outflow channel.

16. The device according to claim 1, wherein a suction bell with its inner volume is connected to the inlet of the inflow channel.

17. The device according to claim 1, wherein a section of the central piece that lies opposite to the tubular element is arranged slidably along the longitudinal center axis in a recess which is spanned open by a pipe piece and which does not have a thread.

18. The device according to claim 1, wherein the section of the central piece lying opposite to the tubular element is arranged in a clamping and rotatable manner in a recess of a pipe piece in which an annular section of a supply line for pressurized fluid is formed, which annular section is connected in a fluid-tight manner to the injection channel.

19. A process for aspirating an object by a device according to claim 1 by applying a pressurized fluid to the supply line and comprising a step of removing a tubular element in which the outflow channel is formed, and/or of removing a pipe piece, in which the inflow channel is formed, from a central piece, cleaning at least one of the central piece, the tubular member and the pipe piece, and reconnecting them to one another.
